(19) United States
(12) Patent Application Publication
(10) Pub. No.: US 2020/0377741 A1
(43) Pub. Date: Dec. 3, 2020

(54) COMPOSITION FOR HARD SURFACE SUBSTRATE MARKING

(71) Applicant: COATEX, Genay (FR)

(72) Inventors: Alexandra FOGUTH, Charlotte, NC (US); Lori HOWELL, Prosperity, SC (US); Haksu LEE, Waxhaw, NC (US)

(73) Assignee: COATEX, Genay (FR)

(21) Appl. No.: 16/770,454

(22) PCT Filed: Jan. 14, 2019
(86) PCT No.: PCT/IB2019/000065

§ 371 Date: Jun. 5, 2020

Related U.S. Application Data
(60) Provisional application No. 62/621,262, filed on Jan. 24, 2018.

(30) Foreign Application Priority Data
Mar. 22, 2018 (EP) 18305316.4

(51) Int. Cl. C09D 7/61; C09D 7/41; C09D 125/14

(52) U.S. Cl. CPC C09D 7/61; C08L 33/02; C09D 125/14; C09D 7/41

(57) ABSTRACT

The invention relates to the field of marking hard surface substrates, in particular to the field of traffic paints. The invention thus provides an aqueous composition useful for marking hard surface substrates. The composition according to the invention comprises a binder and a pigment that is dispersed with a particular (meth)acrylic polymer. The invention also provides a method for preparing such a composition as well as a method for marking a hard surface substrate with such a composition.

The invention relates to the field of marking hard surface substrates, in particular to the field of traffic paints. The invention thus provides an aqueous composition useful for marking hard surface substrates. The composition according to the invention comprises a binder and a pigment that is dispersed with a particular (meth)acrylic polymer.

The invention also provides a method for preparing such a composition as well as a method for marking a hard surface substrate with such a composition.

Compositions comprising a binder and a pigment dispersed with a dispersing agent for marking hard surface substrates are known. In particular, there exists such compositions for the preparation of traffic paints. Generally, the binder that is used in such compositions is a latex binder.

An essential property for such compositions is their ability to dry rapidly once applied on a hard substrate, in particular on a substrate that is aimed for traffic of vehicles or for traffic of persons. Fast drying is of particular importance in high humidity conditions.

Good drying time normally corresponds to improved performance in certain tests, notably in test where no-pick up time of a film coating is measured.

A consequence of improving fast drying of such compositions is generally a negative impact on their stability.

There is thus a need for such compositions having improved stability, in particular for such compositions having improved stability while minimizing their drying time.

Traffic paints should also provide for good wear resistance, either for safety reasons but also for economic reasons. Wear resistance of a film coating is normally the ability of this film coating applied on a surface to resist to detachment or separation from the substrate. Such a detachment or separation can occur for various reasons but is normally depending from the use conditions of the film coating that include the level of traffic, the weather conditions as well as the intrinsic specifications of the film coating.

Known dispersant agents used in compositions for traffic paints are ammonium salts of polyacrylic acid or ammonium salts of polymethacrylic acid, wherein volatility of ammonia is considered helping accelerating drying time of these compositions.

However, stability of these known compositions is not always sufficient or not always satisfying.

Apart, controlling the rheology, in particular the viscosity, of compositions for marking hard surface substrates is also an essential property, either during their preparation but also during their application. Improving the stability of these compositions during their shelf life is also necessary.

Controlling the rheology, in particular the viscosity, of such compositions also allows for an easier use, notably in situations where these compositions must be pumped or must be sprayed.

Fineness of ground pigments used in paints is also important since coarse pigment particles generally reduce the properties of a paint, notably color uniformity and opacity. Grinding efficiency of the pigment, including grinding time, is also important in the course of preparing the pigments to be incorporated in the compositions for marking hard surface substrate.

Satisfying regulations or certain standards is also important for compositions for marking hard surface substrates, notably for traffic paints, in particular when shorter drying time is required.

Document EP 2167595 describes polymers useful in controlling corrosion in coatings. These carboxylic acid-acrylonitrile-styrene polymers can be partially neutralized by dimethylethanolamine. Document EP 2655450 discloses paint compositions comprising a binder bearing acid groups. Document DE 10331053 relates to the use of a hydrophobic polymer combined with a cation modifying agent, for altering the surface of a substrate.

Known compositions do not always provides the necessary properties for addressing these problems. There is thus a need for improved compositions for marking hard surface substrates, notably for traffic paints.

The composition according to the invention provides a solution to all or part of these problems.

The invention thus provides an aqueous hard surface substrate marking composition comprising:
(a) at least one binder;
(b) at least one pigment;
(c) at least one polymer
   obtained further to at least one polymerization reaction of at least one monomer selected from acrylic acid, methacrylic acid, itaconic acid and their salts, and
   partially or totally neutralized
      by at least one divalent cation or
      by at least one divalent cation and at least one monovalent cation or
      by at least one divalent cation and at least one amino compound.

The aqueous composition according to the invention is a waterborne composition whereby its active components are conveyed by water.

Preferably, the hard surface substrate marking composition according to the invention comprises:
from 14.8 to 54.8 weight %, more preferably from 24.5 to 49.5 weight %, of at least one binder (a);
from 45 to 85 weight %, more preferably from 50 to 75 weight %, of at least one pigment (b);
from 0.2 to 10 weight %, more preferably from 0.5 to 5 weight %, of at least one polymer (c).

Preferably according to the invention, the substrate is selected from wood, reconstituted wood products, concrete, asphalt, cement, fiber cement, stone, marble, clay, plaster, masonry, wallboard, paper, cardboard, ferrous metal, non-ferrous metal, plastics (for example, polystyrene, polyethylene, ABS, polyurethane, polyethylene terphthalate, polybutylene terphthalate, polypropylene, polyphenylene, polycarbonate, polyacrylate, PVC, polysulfone or mixtures thereof) and combinations thereof. The preferred substrate according to the invention is selected from concrete, asphalt, cement, fiber cement, stone, marble, clay, plaster, masonry, wallboard and combinations thereof, while the preferred substrate according to the invention is selected from concrete and asphalt.

For the composition according to the invention, binder (a) can be selected in a broad range of binders. Advantageously, binder (a) renders the composition according to the invention being capable of forming a film at ambient temperature or at a greater temperature, preferably at a temperature between 20 and 55° C.

Preferably, binder (a) has glass transition temperature (T_{g}) greater than −40° C. or below the application temperature of the composition. More preferably the T_{g} of binder (a) is between −40 and 150° C., even more preferably between −20 and 100° C. or between −10 and 60° C., in particular between 0 and 50° C.

Also preferably, binder (a) is a polymer latex. Still also preferably, binder (a) is selected from polyvinyl acetate resins, polyvinyl acetate latexes, methyl methacrylate resins, acrylic resins, styrenic resins, styrene-acrylic resins, linseed resins, soya oil resins, alkyd resins and combinations thereof. Particularly preferred binder (a) is selected from acrylic resins, styrene-acrylic resins and combinations thereof. Examples of binders can be selected from products like Arkema Encor DT 250, Arkema Encor DT 400, Arkema Encor DT 211 or Arkema Encor DT 100.

According to the invention, pigment (b) can be selected in a number of categories of pigments. Organic pigments or inorganic pigments can be included in the composition according to the invention. Preferably, pigment (b) is a coloring pigment. More preferably pigment (b) is a coloring pigment selected from a white coloring pigment, a yellow coloring pigment, an orange coloring pigment, a red coloring pigment, a blue coloring pigment, a green coloring pigment and a black coloring pigment.

Also preferably, pigment (b) is selected from titanium dioxide, zinc dioxide, zinc sulfide, barium dioxide, barium sulfate, lithopone, carbon black, organic pigments and combinations thereof. Most preferred pigment (b) is selected from titanium dioxide and organic pigments.

Polymer (c) is an essential component of the composition according to the invention. Polymer (c) primarily acts as a dispersing agent within the composition according to the invention, in particular for dispersing pigment (b). Preferably, polymer (c) is obtained from a polymerization reaction of acrylic acid.

More preferably, polymer (c) is partially or totally neutralized. Even more preferably it is totally neutralized.

Polymer (c) is neutralized by at least one divalent cation selected from cations of Ca, Mg, Zn. Polymer (c) can also be neutralized by at least one divalent cation selected from cations of Ca, Mg, Zn and by at least one monovalent cation selected from cations of Na, K, Li. Polymer (c) can also be neutralized by at least one divalent cation selected from cations of Ca, Mg, Zn and by at least one amino compound. Most preferably, polymer (c) is totally or partially neutralized by Ca.

Preferred polymer (c) according to the invention is totally or partially neutralized by at least one divalent cation and at least one monovalent cation, in a (divalent cation/monovalent cation) molar ratio from 0.1 to 10, more preferably from 0.2 to 5, even more preferably from 0.8 to 3 and most preferably from 1 to 2.5. In such a preferred polymer (c) according to the invention, the divalent cation can be replaced by at least one amino compound.

More preferred polymer (c) according to the invention is totally or partially neutralized by at least one divalent cation selected from cations of Ca, Mg, Zn and a least one monovalent cation selected from cations of Na, K, Li, in a (divalent cation/monovalent cation) molar ratio from 0.1 to 10, more preferably from 0.2 to 5, even more preferably from 0.8 to 3 and most preferably from 1 to 2.5. In such a more preferred polymer (c) according to the invention the divalent cation can be replaced by at least one amino compound.

Particularly preferred polymer (c) according to the invention is totally neutralized by Na and Ca, in particular in a Na/Ca molar ratio from 0.1 to 10. More preferably, the Na/Ca molar ratio is from 0.2 to 5, even more preferably from 0.8 to 3 and most preferably from 1 to 2.5.

Also preferably, polymer (c) according to the invention can be totally or partially neutralized by Ca and Na, Mg and Na, Ca and K, Mg and K, Ca and Mg and Na, Ca and Mg and K, Ca and Na and K, Mg and Na and K, Ca and Mg and Na and K, in particular in a (divalent cation/monovalent cation) molar ratio from 0.1 to 10, more preferably from 0.2 to 5, even more preferably from 0.8 to 3 and most preferably from 1 to 2.5.

Various compounds can be used for the neutralization of polymer (c). Preferably, polymer (c) is partially or totally neutralized, by mean of at least one compound selected from Ca(OH)₂, Mg(OH)₂, Ba(OH)₂, CaO, MgO, ZnO, NaOH, KOH, LiOH and combinations thereof.

According to the invention, polymer (c) has a pH that can vary. Preferably, this pH is greater than 5, even preferably greater than 5.5 or greater than 6. Also preferably, this pH is below than 10.

According to the invention, polymer (c) has a molecular weight (M_{W}—measured by SEC) that can vary. Preferably, polymer (c) has a molecular weight (M_{W}—measured by SEC) below 15,000 g/mol or below 12,000 g/mol, preferably below 10,000 g/mol or between 1,000 and 10,000 g/mol, equally preferably below 8,000 g/mol or between 1,000 and 8,000 g/mol, more preferably below 6,500 g/mol or between 1,500 and 6,500 g/mol, even more preferably below 6,000 g/mol or between 2,000 and 6,000 g/mol.

According to the invention, polymer (c) has a polymolecular index that can vary. Preferably, polymer (c) has a polymolecular index below 3.5, more preferably below 3 or below 2.8. Even more preferably, polymer (c) has a polymolecular index below 2.5 or below 2.2.

According to the invention, polymer (c) can be selected from homopolymers (c) of one monomer selected from acrylic acid, methacrylic acid, itaconic acid and their salts and copolymers (c) of at least one further monomer and at least of one monomer selected from acrylic acid, methacrylic acid, itaconic acid and their salts.

Preferred homopolymers (c) according to the invention can be selected from homopolymers of acrylic acid.

According to the invention, the further monomer useful for preparing copolymers (c) according to the invention is preferably selected from:
at least one anionic monomer selected acrylic acid, methacrylic acid, itaconic acid, maleic acid, maleic anhydride, crotonic acid and their salts;
at least one non-ionic monomer selected from esters of a carboxylic acid, preferably esters of acids selected from acrylic acid, methacrylic acid, itaconic acid, maleic acid, maleic anhydride, crotonic acid; more preferably selected from styryl-vinylcaprolactam, alkylacrylate, in particular C₁-C₁₀-alkyl-acrylate or C₁-C₄-alkyl-acrylate, more preferably selected from methyl-acrylate, ethyl-acrylate, propyl-acrylate, isobutyl-acrylate, n-butyl-acrylate, alkyl-methacrylate, in particular C₁-C₁₀-alkyl-methacrylate or C₁-C₄-alkyl-methacrylate, more preferably methyl-methacrylate, ethyl-methacrylate, propyl-methacrylate, isobutyl-methacrylate, n-butyl-methacrylate, aryl-acrylate, preferably phenylacrylate, benzylacrylate, phenoxyethylacrylate, aryl-methacrylate, preferably phenylmethacrylate, benzylmethacrylate, phenoxyethylmethacrylate, hydroxyethyl-acrylate, hydroxypropyl-acrylate, hydroxyethylhexyl-acrylate, hydroxyethyl-methacrylate, hydroxypropyl-methacrylate, hydroxyethylhexyl-methacrylate, a compound of formula (1):

R¹-(L¹)ₘ-(L²)ₙ-R² (1)
wherein:
   R¹ represents an acrylate group that can be polymerized or a methacrylate group that can be polymerized,
   R² represents OH or OCH₃,
   L¹ and L², identical or different, independently represent an ethylene-oxy group or an oxy-propylene group and
   m and n, identical or different, at least one not being null, represent a number below or equal to 150 and their sum m+n is below 150;
2-acrylamido-2-methylpropane-sulfonic acid (AMPS), a salt of 2-acrylamido-2-methylpropane-sulfonic acid, 2-(methacryloyloxy)ethanesulfonic acid, a salt of 2-(methacryloyloxy)ethanesulfonic acid, sodium methallyl-sulfonate, sodium styryl-sulfonate, hydroxyethyl-phosphate-acrylate, hydroxypropyl-phosphate-acrylate, hydroxyethylhexyl-phosphate-acrylate, hydroxyethyl-phosphate-methacrylate, hydroxypropyl-phosphate-methacrylate, hydroxyethylhexyl-phosphate-methacrylate and combinations thereof.

Preferred copolymers (c) according to the invention can be selected from copolymers of acrylic acid and methacrylic acid, copolymers of acrylic acid, methacrylic acid and AMPS, copolymers of acrylic acid and AMPS, copolymers of acrylic acid and alkyl methacrylates (like ethyl methacrylate), copolymers of acrylic acid and alkyl acrylates (like ethyl acrylate), copolymers of acrylic acid, alkyl methacrylates (like ethyl methacrylate) and AMPS, copolymers of acrylic acid, alkyl acrylates (like ethyl acrylate) and AMPS, copolymers of acrylic acid and itaconic acid, copolymers of acrylic acid, itaconic acid and AMPS.

Equally preferred copolymers (c) according to the invention are obtained further to at least one polymerization reaction of 70 to 99.5 weight % of at least one monomer selected from acrylic acid, methacrylic acid, itaconic acid and their salts, and of 0.5 to 30 weight % of at least one further monomer as herein-defined.

Homopolymer (c) and copolymer (c) according to the invention can be prepared by known radical polymerization methods, for example they can be prepared in solution, in direct emulsion or in inversed emulsion, in suspension or in precipitation from an appropriate solvent. They can be prepared in presence of at least one catalytic system and in presence of at least one chain transfer agent.

They can be prepared by controlled radical polymerization methods, for example such methods controlled by nitroxides (NMP) or controlled by cobaloximes, or prepared by atom transfer radical polymerization (ATRP) methods. Radical polymerization methods controlled by sulfur derivatives chosen from carbamates, dithioesters, trithiocarbonates (RAFT) and xanthates can also be implemented for the preparation of homopolymer (c) or of copolymer (c) according to the invention.

Examples of initiators are hydrogen peroxide or various persulfate derivatives. Examples of chain transfer agents are copper sulfate or various hypophosphite derivatives like sodium hypophosphite, potassium hypophosphite, calcium hypophosphite, hypophosphorous acid, mercaptan derivatives, secondary alcohols and thiolactic acid. Initiators and chain transfer agents can be combined.

The composition according to the invention is an aqueous composition but it can also include at least one solvent in admixture with water. Preferably, such a solvent is selected from water miscible organic solvents, such as alcohols and glycol ethers. Examples of such solvents can be selected from Texanol ester alcohol (CAS #25265-77-4), Dowanol dipropylene glycol methyl ether (CAS #34590-94-8), Dowanol propylene glycol methyl ether (CAS #107-98-2), Dowanol propylene glycol n-propyl ether (CAS #1569-01-3), Dowanol dipropylene glycol n-propyl ether (CAS #29911-27-1), Dowanol dipropylene glycol n-butyl ether (CAS #29911-28-2), Butyl Cellosolve ethylene glycol monobutyl ether (CAS #111-76-2), Butyl Carbitol dietheylene glycol monobutyl ether (CAS #112-34-5), Methyl Carbitol dietheylene glycol monomethyl ether (CAS #111-77-3), diisobutyl ketone (CAS #108-83-8), methanol (CAS #67-56-1).

In addition to binder (a), pigment (b) and polymer (c), the composition according to the invention can comprise further components. Preferably, the composition according to the invention further comprises at least one extender compound, preferably at least one compound selected from natural calcium carbonate, synthetic calcium carbonate, barium carbonate, talc, clays, silicas, silicates and combinations thereof.

The composition according to the invention can additionally comprise at least one further additive, preferably at least one additive selected from thickeners, rheology modifiers, dyes, artificial light reflecting agents, natural light reflecting agents, sequestering agents, biocides, dispersants, fillers (for example microspheres or beads of a material selected from glass, polymer, quartz and sand), anti-freeze agents, plasticizers, adhesion promoters, coalescence agents, wetting agents, waxes, surfactants, slip additives, crosslinking agents, defoamers, colorants, preservatives, freeze protectors, thaw protectors, corrosion inhibitors, alkali soluble polymers, water soluble polymers and combinations thereof.

The invention not only provides a composition but also provides various methods derived from this composition or for implementing this composition.

The invention thus also provides a method (M1) for preparing an aqueous marking composition for hard surface substrate comprising adding at least one polymer (c)
obtained further to at least one polymerization reaction of at least one monomer selected from acrylic acid, methacrylic acid, itaconic acid and their salts, and
partially or totally neutralized
   by at least one divalent cation or
   by at least one divalent cation and at least one monovalent cation or
   by at least one divalent cation and at least one amino compound;
      to an aqueous composition also comprising at least one binder (a) and at least one pigment (b).

The invention also provides a method (M2) for marking a hard surface substrate comprising the application to the surface of the substrate of at least one aqueous marking composition, comprising:
(a) at least one binder;
(b) at least one pigment;
(c) at least one polymer
   obtained further to at least one polymerization reaction of at least one monomer selected from acrylic acid, methacrylic acid, itaconic acid and their salts, and
   partially or totally neutralized
      by at least one divalent cation or
      by at least one divalent cation and at least one monovalent cation or
      by at least one divalent cation and at least one amino compound.

Preferably, for method (M2) according to the invention, the composition is applied by a method selected from air spray, air-assisted airless spray, high volume-low pressure (HVLP) spray, low volume-low pressure (LVLP) spray, hot spray, airless spray, roll, brush, curtain, flood, and dip-coating methods. Also preferably, for method (M2) according to the invention, the composition is contacted with at least one coagulant agent further to its application on the substrate.

The invention also provides a method (M3) for improving stability of an aqueous marking composition for hard surface substrate. Method (M3) according to the invention comprises adding to an aqueous composition also comprising at least one binder and at least one pigment, at least one polymer
obtained further to at least one polymerization reaction of at least one monomer selected from acrylic acid, methacrylic acid, itaconic acid and their salts, and
partially or totally neutralized
   by at least one divalent cation or
   by at least one divalent cation and at least one monovalent cation or
   by at least one divalent cation and at least one amino compound.

The invention also provides a method (M4) for improving drying time of an aqueous marking composition for hard surface substrate. Method (M4) according to the invention comprises adding to an aqueous composition also comprising at least one binder and at least one pigment, at least one polymer
obtained further to at least one polymerization reaction of at least one monomer selected from acrylic acid, methacrylic acid, itaconic acid and their salts, and
partially or totally neutralized
   by at least one divalent cation or
   by at least one divalent cation and at least one monovalent cation or
   by at least one divalent cation and at least one amino compound.

For methods (M1), (M2), (M3) or (M4) according to the invention, the composition or the substrate are defined according to the composition or to the substrate according to the invention. In addition, the preferred, particular, advantageous or specific features of the composition according to the invention allow defining corresponding preferred, particular, advantageous or specific methods (M1), (M2), (M3) and (M4) according to the invention.

The following examples provide specific illustrations of the various aspects of the invention.

### EXAMPLE 1: PREPARATION OF POLYMER (C1) ACCORDING TO THE INVENTION

In a synthesis reactor fitted with a mechanical stirring system and a heating system of oil bath type, are introduced:
water: 241.069 g,
copper sulfate pentahydrate: 0.323 g,
ferrous sulfate heptahydrate: 0.276 g.

The medium is heated to 95° C., and then the following elements are simultaneously and continuously added, over 2 hours:
an aqueous solution of 3.5 g of 20.9 wt. % DPTTC sodium salt (CAS #86470-33-2), diluted in 31 g of water,
35.3 g of hydrogen peroxide 130 V diluted in 9.4 g of water and
279.9 g of acrylic acid diluted in 31 g of water.

Cooking continues for 1.5 h at 95° C.

A solution of polyacrylic acid having a Mw of 5,700 g/mol and an Ip of 2.5 is obtained.

The solution of polyacrylic acid is treated with:
caustic soda 50 wt. % in water: 145 g,
water: 66.660 g,
hydrated lime 97 wt. % in water: 42.5 g.

The pH of resulting polymer (c1) is finally adjusted to 8.7 with soda and to a final concentration of 38% dry matter in water.

### EXAMPLE 2: PREPARATION OF POLYMER (C2) ACCORDING TO THE INVENTION

In a synthesis reactor fitted with a mechanical stirring system and a heating system of oil bath type, are introduced:
water 163.4 g,
sodium hypophosphite solution 50 wt. % in water: 3.17 g.

The medium is heated to 97° C., and then the following elements are simultaneously and continuously added, over 3 hours:
a solution of 2.12 g of sodium persulfate, diluted in 58.3 g of water,
14.3 g of a sodium hypophosphite solution (50 wt. % in water) diluted in 47 g of water,
254.2 g of acrylic acid diluted with 19 g of water.

Cooking continues for 30 min at 95° C.

A solution of polyacrylic acid having a Mw of 4,500 g/mol and an Ip of 2.25 is obtained. The solution of polyacrylic acid is treated with:
caustic soda 50 wt. % in water: 78.7 g,
water: 150 g,
hydrated lime 97 wt. % in water: 68.6 g.

The pH of resulting polymer (c2) is finally adjusted to 8.5 with soda and to a final concentration of 35% dry matter in water.

### EXAMPLE 3: EVALUATIONS OF POLYMERS (C1) AND (C2)

Properties of polymers (c1) and (c2) according to the invention have been compared to comparative polymers that are:
comparative polymer (cp1) is homopolymer of methacrylic acid that is 100 wt. % ammonium neutralized: Tamol 901 (Dow Chemicals),
comparative polymer (cp2) is homopolymer of acrylic acid that is 100 wt. % ammonium neutralized: Tamol 963 (Dow Chemicals),
comparative polymer (cp3) is homopolymer of methacrylic acid that is 100 wt. % sodium neutralized: Tamol 851 (Dow Chemicals),
comparative polymer (cp4) is homopolymer of acrylic acid that is 100 wt. % sodium neutralized: Rhodoline 226/35 851 (Solvay),
comparative polymer (cp5) is homopolymer of acrylic acid that is 100 wt. % sodium neutralized: Ecodis P30 (Coatex),
comparative polymer (cp6) is homopolymer of acrylic acid that is 100 wt. % ammonium neutralized: Ecodis P90 (Coatex),
comparative polymer (cp7) is homopolymer of acrylic acid that is 100 wt. % sodium neutralized: Ecodis P50 (Coatex).

Traffic paint compositions have been prepared by using polymers (c) according to the invention by mixing the various components. Similarly, comparative paint compositions have been prepared that include known polymers. Products and respective amounts have been employed and introduced according to table 1.

TABLE 1

| paint composition components | | kilograms | liter |
|---|---|---|---|
| binder | Encor DT 250 (Arkema) | 192.78 | 187.00 |
| solvent | water | 16.78 | 16.66 |
| preservative | Proxel GXL (Excel) | 0.91 | 0.76 |
| surfactant | Triton CF-10 (Dow) | 0.91 | 0.76 |
| defoamer | Drewplus L-475 (Ashland) | 1.36 | 1.14 |
| dispersant | polymer (c) | 4.54 | 3.79 |
| titanium dioxide | Tronox CR-828 (Tronox) | 45.36 | 11.36 |
| calcium carbonate | Omyacarb 5-FL (Omya) | 299.37 | 110.91 |
| coalescing solvent | Texanol (Eastman) | 9.07 | 9.46 |
| defoamer | Drewplus L-475 (Ashland) | 0.91 | 1.14 |
| solvent | methanol | 15.88 | 20.06 |
| cellulosic thickener | Natrosol 250 HBR (Ashland) | 0.09 | 0.38 |
| solvent | water | 14.97 | 15.14 |
| | total | 602.92 | 378.54 |

The components were mixed for 15 minutes. The fineness of dispersions has been evaluated in accordance with ASTM D1210 of 2005 (Test Method for Fineness of Dispersion of Pigment-Vehicle Systems by Hegman-Type Gage). The components were allowed to mix for 15 minutes or until the fineness of grind was not less than 4 Hegman units. The results obtained are presented in table 2.

TABLE 2

| Polymer | grinding time (min) |
|---|---|
| (c1) | 15 |
| (c2) | 15 |
| (cp1) | 45 |
| (cp2) | 45 |
| (cp3) | 60 |
| (cp6) | 60 |

Using polymers (c1) and (c2) according to the invention allows better grinding efficiency, or faster grinding time versus comparative polymers.

Coating films prepared with paint compositions comprising dispersions of pigments using polymers (c) according to the invention and comparative polymers have been evaluated. This evaluation has been performed in accordance with ASTM D 823 of 1995 (Practices for Producing Films of Uniform Thickness of Paint, Varnish, and Related Products on Test Panels—reapproved in 2001). The results obtained are presented in table 3.

TABLE 3

| polymer | Hegman value at 15 min |
|---|---|
| (c1) | 5.5 |
| (c2) | 5.5 |
| (cp1) | 3 |
| (cp2) | 3 |
| (cp3) | 3 |
| (cp6) | 3 |

Polymers (c1) and (c2) according to the invention allows higher Hegman values at 15 minutes versus comparative polymers.

Stability of dispersions of pigments using polymers (c) according to the invention and comparative polymers has been evaluated. This evaluation has been is performed in accordance with ASTM D 1849 of 1995 (Test Method for Package Stability of Paint—reapproved in 2014). Samples were evaluated for 1 week at 60° C. The results are presented in table 4.

TABLE 4

| polymer | stability (delta KU) |
|---|---|
| (c1) | 7.2 |
| (c2) | 18.2 |
| (cp1) | 48.0 |
| (cp2) | gelled |
| (cp3) | gelled |
| (cp4) | 41.5 |
| (cp5) | 49.0 |
| (cp6) | gelled |
| (cp7) | 47.4 |

Using polymers (c1) and (c2) allows less increase in KU versus comparative polymers without any gel formation. On the contrary, comparative using comparative polymers (cp2), (cp3), and (cp7) caused the paint to gel so it was not possible to measure the KU viscosity.

75% humidity dry time of dispersions of pigments using polymers (c) according to the invention and comparative polymers has been evaluated. This evaluation has been performed in accordance with ASTM D 711 of 2010 (Test Method for No Pick-Up Time of Traffic Paint). A steel cylinder fitted with two replaceable O-rings that is rolled down a ramp over a film drawdown over a glass panels with a wet film thickness of 381 (corresponding to US 15 mils), has been used. The results obtained are presented in table 5.

TABLE 5

| polymer | 75% humidity dry time (min) |
|---|---|
| (c2) | 11 |
| (cp1) | 25 |
| (cp2) | gelled |
| (cp3) | 22 |
| (cp4) | 15 |

Using polymers (c2) according to the invention allows faster dry time for polymer (c2) versus comparative polymers. Comparative polymer (cp2) gelled overnight thus the dry time could not be measured.

Set-to-touch time for 50% humidity dry time of dispersions of pigments using polymers (c) according to the invention and comparative polymers has been evaluated. This evaluation has been performed in accordance with ASTM D 1640 of 2003 (Standard Test Methods for Drying, Curing, or Film Formation of Organic Coatings at Room Temperature, Procedure 7.2 Set-To-Touch Time for 50% humidity dry time). The results obtained are presented in table 6.

TABLE 6

| Polymer | 50% humidity dry time (min) |
|---|---|
| (c2) | 5 |
| (cp1) | 6 |
| (cp3) | 7 |
| (cp4) | 8 |
| (cp5) | 7 |
| (cp6) | 8 |
| (cp7) | 6 |

Faster dry time can be obtained while using polymer (c2) according to the invention versus using comparative polymers.

1. An aqueous composition for hard surface substrate marking, comprising:
at least one binder;
at least one pigment; and
at least one polymer,
wherein the at least one polymer is obtained from at least one polymerization reaction of at least one monomer selected from the group consisting of an acrylic acid, a methacrylic acid, an itaconic acid, a salt of an acrylic acid, a salt of a methacrylic acid, and a salt of an itaconic acid, and
wherein the at least one polymer is partially or totally neutralized
by at least one divalent cation, or
by at least one divalent cation and at least one monovalent cation, or
by at least one divalent cation and at least one amino compound.

2. The aqueous composition for hard surface substrate marking according to claim 1, wherein the hard surface substrate is at least one selected from the group consisting of wood, a reconstituted wood product, concrete, asphalt, cement, fiber cement, stone, marble, clay, plaster, masonry, wallboard, paper, cardboard, ferrous metal, non-ferrous metal, a plastic, (polystyrene, polyethylene, ABS, polyurethane, polyethylene terphthalate, polybutylene terphthalate, polypropylene, polyphenylene, polycarbonate, polyacrylate, PVC, polysulfone.

3. The aqueous composition for hard surface substrate marking according to claim 1, wherein the at least one binder:
has a glass transition temperature (T_{g}) greater than −40° C. or below an application temperature of the composition; or
is at least one selected from the group consisting of a polymer latex, a polyvinyl acetate resin, a polyvinyl acetate latex, a methyl methacrylate resin, an acrylic resin, a styrenic resin, a styrene-acrylic resin, a linseed resin, a soya oil resin, an alkyd resin, and combinations thereof; or
allows the composition to form a film at an ambient temperature or greater.

4. The aqueous composition for hard surface substrate marking according to claim 1, wherein the at least one pigment:
is an organic pigment or an inorganic pigment; or
is a coloring pigment; or
is at least one selected from the group consisting of titanium dioxide, zinc dioxide, zinc sulfide, barium dioxide, barium sulfate, lithopone, carbon black, an organic pigment, and combinations thereof.

5. The aqueous composition for hard surface substrate marking according to claim 1, wherein the at least one polymer:
is obtained from a polymerization reaction of acrylic acid; or
is partially or totally neutralized,
by at least one divalent cation selected from the group of cations consisting of Ca, Mg, and Zn; or
by at least one divalent cation selected from the group of cations consisting of Ca, Mg, and Zn, and by at least one monovalent cation selected from the group of cations consisting of Na, K, and Li; or
by at least one divalent cation selected from the group of cations consisting of Ca, Mg, and Zn, and by at least one amino compound; or
is partially or totally neutralized by at least one compound selected from the group consisting of Ca(OH)₂, Mg(OH)₂, Ba(OH)₂, CaO, MgO, ZnO, NaOH, KOH, LiOH, and combinations thereof; or
has a pH greater than 5; or
has a pH below 10; or
has a molecular weight M_{W} measured by SEC of below 15,000 g/mol; or
has a polymolecular index below 3.5.

6. The aqueous composition for hard surface substrate marking according to claim 1, wherein the at least one polymer is totally or partially neutralized by at least one divalent cation and at least one monovalent cation having a divalent cation to monovalent cation molar ratio in a range of from 0.1 to 10.

7. The aqueous composition for hard surface substrate marking according to claim 1, wherein the at least one polymer is totally or partially neutralized by at least one divalent cation selected from the group of cations consisting of Ca, Mg, and Zn, and by a least one monovalent cation selected from the group of cations consisting of Na, K, and Li, and
wherein the at least one divalent cation and the at least one monovalent cation have a divalent cation to monovalent cation molar ratio in a range of from 0.1 to 10.

8. The aqueous composition for hard surface substrate marking according to claim 1, wherein the at least one polymer is totally neutralized by Na and Ca.

9. The aqueous composition for hard surface substrate marking according to claim 1, further comprising:
at least one extender compound selected from the group consisting of a natural calcium carbonate, a synthetic calcium carbonate, a barium carbonate, a talc, a clay, a silica, a silicate, and combinations thereof; or
at least one solvent in admixture with water; or
at least one additive selected from the group consisting of a thickener, a rheology modifier, a dye, an artificial light reflecting agent, a natural light reflecting agent, a sequestering agent, a biocide, a dispersant, a filler, a glass microsphere, a glass bead, a polymer microsphere, a polymer bead, a quartz microsphere, a quartz bead, a sand microsphere, a sand bead, an anti-freeze agent, a plasticizer, an adhesion promoter, a coalescence agent, a wetting agent, a wax, a surfactant, a slip additive, a crosslinking agent, a defoamer, a colorant, a preservative, a freeze protector, a thaw protector, a corrosion inhibitor, an alkali soluble polymer, a water soluble polymer, and combinations thereof.

10. A method for preparing an aqueous composition for hard surface substrate marking, the method comprising adding at least one polymer to an aqueous composition comprising at least one binder and at least one pigment,
wherein the at least one polymer is obtained from at least one polymerization reaction of at least one monomer selected from the group consisting of an acrylic acid, a methacrylic acid, an itaconic acid, a salt of an acrylic acid, a salt of a methacrylic acid, and a salt of an itaconic acid, and
wherein the at least one polymer is partially or totally neutralized:
by at least one divalent cation, or
by at least one divalent cation and at least one monovalent cation, or
by at least one divalent cation and at least one amino compound.

11. A method for marking a hard surface substrate comprising contacting a surface of the hard surface substrate with at least one aqueous marking composition, the at least one aqueous marking composition comprising:
at least one binder;
at least one pigment; and
at least one polymer,
wherein the at least one polymer is obtained from at least one polymerization reaction of at least one monomer selected from the group consisting of an acrylic acid, a methacrylic acid, an itaconic acid, a salt of an acrylic acid, a salt of a methacrylic acid, and a salt of an itaconic acid, and
wherein the at least one polymer is partially or totally neutralized:
by at least one divalent cation, or
by at least one divalent cation and at least one monovalent cation, or
by at least one divalent cation and at least one amino compound.

12. The method according to claim 11, wherein the at least one aqueous marking composition contacts the hard surface substrate by a method selected from the group consisting of air spray, air-assisted airless spray, HVLP spray, LVLP spray, hot spray, airless spray, roll, brush, curtain, flood, a dip-coating method, and combinations thereof; or
wherein the method further comprises contacting the at least one aqueous marking composition with at least one coagulant agent after the contacting of the surface of the hard surface substrate with the at least one aqueous marking composition.

13. A method for improving stability of an aqueous marking composition for a hard surface, the method comprising adding at least one polymer to an aqueous composition comprising at least one binder and at least one pigment,
wherein the at least one polymer is obtained from at least one polymerization reaction of at least one monomer selected from the group consisting of an acrylic acid, a methacrylic acid, an itaconic acid, a salt of an acrylic acid, a salt of a methacrylic acid, and a salt of an itaconic acid, and
wherein the at least one polymer is partially or totally neutralized:
by at least one divalent cation, or
by at least one divalent cation and at least one monovalent cation, or
by at least one divalent cation and at least one amino compound.

14. A method for improving a drying time of an aqueous marking composition for a hard surface, the method comprising adding at least one polymer to an aqueous composition comprising at least one binder and at least one pigment,
wherein the at least one polymer is obtained from at least one polymerization reaction of at least one monomer selected from the group consisting of an acrylic acid, a methacrylic acid, an itaconic acid, a salt of an acrylic acid, a salt of a methacrylic acid, and a salt of an itaconic acid, and
wherein the at least one polymer is partially or totally neutralized:
by at least one divalent cation, or
by at least one divalent cation and at least one monovalent cation, or
by at least one divalent cation and at least one amino compound.

15. The method according claim 10, wherein the aqueous composition for hard surface substrate marking comprises:
the at least one binder;
the at least one pigment; and
the at least one polymer, and
wherein the hard surface substrate is at least one selected from wood, a reconstituted wood product, concrete, asphalt, cement, fiber cement, stone, marble, clay, plaster, masonry, wallboard, paper, cardboard, ferrous metal, non-ferrous metal, a plastic, polystyrene, polyethylene, ABS, polyurethane, polyethylene terphthalate, polybutylene terphthalate, polypropylene, polyphenylene, polycarbonate, polyacrylate, PVC, polysulfone, and combinations thereof.

16. The method according claim 11, wherein the hard surface substrate is at least one selected from the group consisting of wood, a reconstituted wood product, concrete, asphalt, cement, fiber cement, stone, marble, clay, plaster, masonry, wallboard, paper, cardboard, ferrous metal, non-ferrous metal, a plastic, polystyrene, polyethylene, ABS, polyurethane, polyethylene terphthalate, polybutylene terphthalate, polypropylene, polyphenylene, polycarbonate, polyacrylate, PVC, polysulfone, and combinations thereof.

17. The method according claim 12, wherein the hard surface substrate is at least one selected from the group consisting of wood, a reconstituted wood product, concrete, asphalt, cement, fiber cement, stone, marble, clay, plaster, masonry, wallboard, paper, cardboard, ferrous metal, non-ferrous metal, a plastic, polystyrene, polyethylene, ABS, polyurethane, polyethylene terphthalate, polybutylene terphthalate, polypropylene, polyphenylene, polycarbonate, polyacrylate, PVC, polysulfone, and combinations thereof.

18. The method according claim 13, wherein the hard surface is at least one selected from the group consisting of wood, a reconstituted wood product, concrete, asphalt, cement, fiber cement, stone, marble, clay, plaster, masonry, wallboard, paper, cardboard, ferrous metal, non-ferrous metal, a plastic, polystyrene, polyethylene, ABS, polyurethane, polyethylene terphthalate, polybutylene terphthalate, polypropylene, polyphenylene, polycarbonate, polyacrylate, PVC, polysulfone, and combinations thereof.

19. The method according claim 14, wherein the hard surface is at least one selected from the group consisting of wood, a reconstituted wood product, concrete, asphalt, cement, fiber cement, stone, marble, clay, plaster, masonry, wallboard, paper, cardboard, ferrous metal, non-ferrous metal, a plastic, polystyrene, polyethylene, ABS, polyurethane, polyethylene terphthalate, polybutylene terphthalate, polypropylene, polyphenylene, polycarbonate, polyacrylate, PVC, polysulfone, and combinations thereof.
